(19) United States
(12) Patent Application Publication
(10) Pub. No.: US 2026/0027956 A1
(43) Pub. Date: Jan. 29, 2026

(54) SIMPLIFIED BASE TRIM COVER FOR SEAT WITH REMOVABLE TRIM COVER

(71) Applicant: Toyota Motor Engineering & Manufacturing North America, Inc., Plano, TX (US)

(72) Inventors: William P. Dix, Highland Park, MI (US); Emily M. Deming, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/785,470

(22) Filed: Jul. 26, 2024

(51) Int. Cl. B60N 2/58

(52) U.S. Cl. CPC B60N 2/5816

(57) ABSTRACT

A trim cover assembly structured to be applied to a backrest of a vehicle seat includes a base trim cover having a rear portion, first side portion extending from a first side of the rear portion, and a second side portion extending from a second side of the rear portion opposite the first side portion. Each side portion is structured to be wrappable along a respective side of the backrest. Each side portion also has a side edge structured to be securable to the backrest along a front face of the backrest. The base trim cover may be attached to the backrest using suitable fasteners (e.g., hog-rings, EZ clips, hook and loop tape, arrow-hooks, stitching, etc.) and conventional upholstery securement methods.

### TECHNICAL FIELD

The present invention relates to vehicle seat upholstery and, more particularly, to a trim cover assembly structured for application to a padded backrest of a vehicle seat.

### BACKGROUND

Conventional base trim covers for vehicle seats may be attached to a padded seat frame by wrapping the trim cover over the top of the seat frame, then zipping zippers built into the trim cover to enclose and compress the seat padding. However, this trim cover structure and method of assembly are difficult and time-consuming due to friction between the foam and the trim cover during wrapping and resistance of the padding to compression during zipping.

### SUMMARY

In one aspect of the embodiments described herein, a trim cover assembly is provided for application to a backrest of a vehicle seat. The trim cover assembly includes a base trim cover having a rear portion, first side portion extending from a first side of the rear portion, and a second side portion extending from a second side of the rear portion opposite the first side portion. Each side portion is structured to be wrappable along a respective side of the backrest, each side portion having a side edge structured to be securable to the backrest along a front face of the backrest.

In another aspect of the embodiments described herein, a method for attaching a trim cover assembly to a vehicle backrest is provided. The method includes a step of applying a portion of a base trim cover to the backrest, including wrapping first and second side portions of the base trim cover along respective sides of the backrest from a rear face of the backrest toward a front face of the backrest. The method also includes a step of securing the first and second side portions of the base trim cover to the backrest along the front face of the backrest.

### BRIEF DESCRIPTION OF THE DRAWINGS

The accompanying drawings, which are incorporated in and constitute a part of the specification, illustrate various systems, methods, and other embodiments of the disclosure. In some embodiments, one element may be designed as multiple elements or multiple elements may be designed as one element. In some embodiments, an element shown as an internal component of another element may be implemented as an external component and vice versa. Furthermore, elements may not be drawn to scale. Also, unless otherwise stated or shown, the same or similar elements shown in different views may be given the same or similar reference numerals or designations.

FIG. 1 is a schematic exploded perspective view of a vehicle seat incorporating a trim cover assembly in accordance with an embodiment described herein.

FIG. 2 is a schematic frontal view of a backrest of the vehicle seat of FIG. 1, showing various sections of padding covering a frame of the backrest.

FIG. 3 is a schematic plan view of a base trim cover structured for covering the backrest of FIG. 2.

FIG. 4A is a schematic plan cross-sectional view of a portion of the backrest of FIG. 2, illustrating an initial stage of application of the base trim cover of FIG. 3 to the backrest.

FIG. 4B is the schematic plan cross-sectional view of FIG. 4A, illustrating a later stage of application of the base trim cover of FIG. 3 to the backrest.

FIG. 4C is the schematic plan cross-sectional view of FIG. 4B, illustrating application of a removable trim cover to the backrest over the base trim cover after the base trim cover has been secured to the backrest.

FIG. 5 is a schematic frontal view of the backrest of FIG. 2 covered by the base trim cover of FIG. 3 after application of the base trim cover to the backrest.

FIG. 5A is a schematic frontal detail view of an upper portion of the backrest of FIG. 5.

FIG. 6 is a schematic exploded perspective view of a vehicle seat incorporating a trim cover assembly in accordance with an alternative embodiment described herein.

FIG. 7 is a schematic plan view of a base trim cover structured for covering the backrest of FIG. 2, in accordance with an alternative embodiment described herein.

### DETAILED DESCRIPTION

A trim cover assembly structured to be applied to a backrest of a vehicle seat includes a base trim cover having a rear portion, first side portion extending from a first side of the rear portion, and a second side portion extending from a second side of the rear portion opposite the first side portion. Each side portion is structured to be wrappable along a respective side of the backrest. Each side portion also has a side edge structured to be securable to the backrest along a front face of the backrest. The base trim cover may be attached to the backrest using suitable fasteners (e.g., hog-rings, EZ clips, hook and loop tape, arrow-hooks, stitching, etc.) and conventional upholstery securement methods. After attachment of the base trim cover to the backrest, a removable trim cover may be attached to the backrest and to the base rim cover. Because the base trim cover is not wrapped over the top of the seat and does not use zippers to attach to the backrest, time and labor are saved during application of the base trim cover to the backrest.

As used herein, the term “upper” refers to a vertically relatively higher position or location, and “lower” refers to a vertically relatively lower position or location, from the perspective of an occupant seated in the vehicle seat when the seat is mounted in a vehicle and the vehicle rests on a ground surface. Similarly, the term “left” refers to a direction on or toward a left side from the perspective of an occupant seated in the vehicle seat when the seat is mounted in a vehicle and the vehicle rests on a ground surface. Also, the term “right” refers to a direction on or toward a right side from the perspective of an occupant seated in the vehicle seat when the seat is mounted in a vehicle and the vehicle rests on a ground surface.

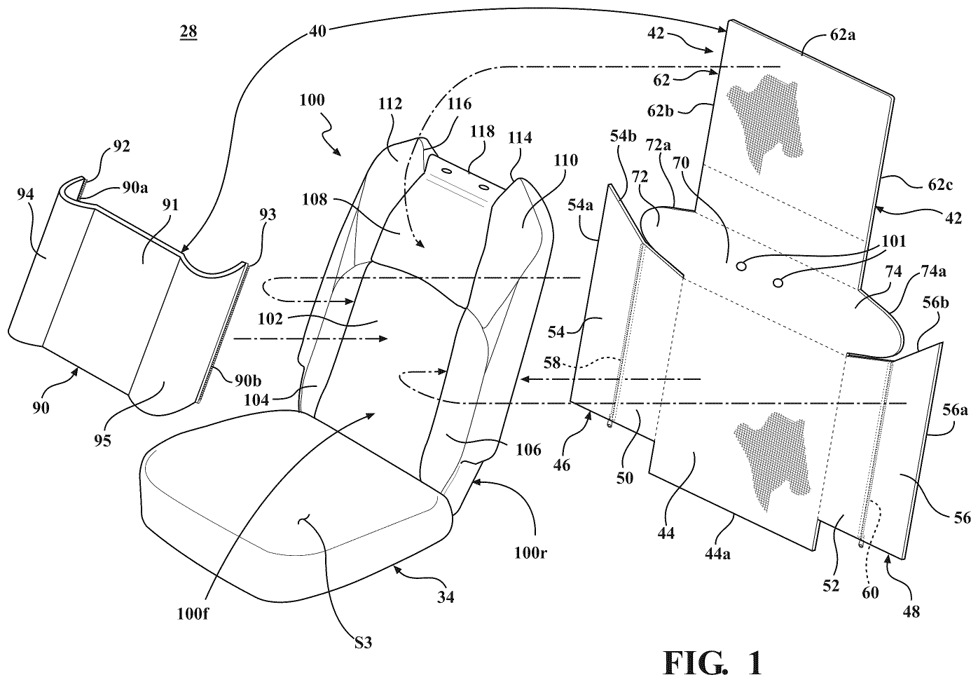

FIG. 1 is a schematic exploded perspective view of a vehicle seat 28 incorporating a trim cover assembly 40 in accordance with an embodiment described herein. The vehicle seat 28 may include a seat bottom 34 and a seat back or backrest 100 extending from a rear of the seat bottom 34 to support the back of a vehicle occupant in a known manner.

The backrest 100 may have a front face 100f structured to face in a direction toward a front of a vehicle in which the vehicle seat 28 is mounted. The backrest 100 may also have a rear face 100r positioned opposite the front face 100f and structured to face in a direction toward a rear of the vehicle in which the vehicle seat 28 is mounted.

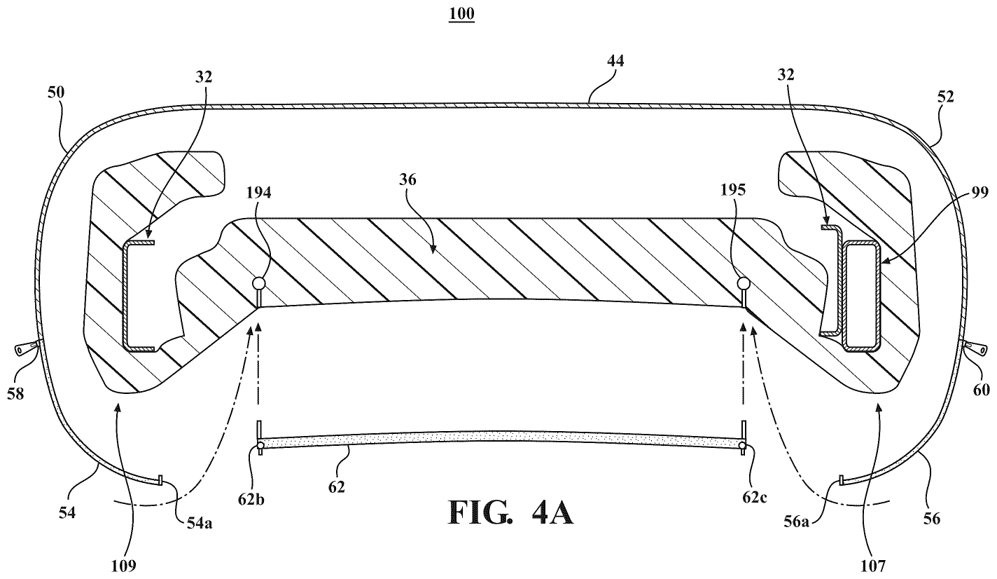

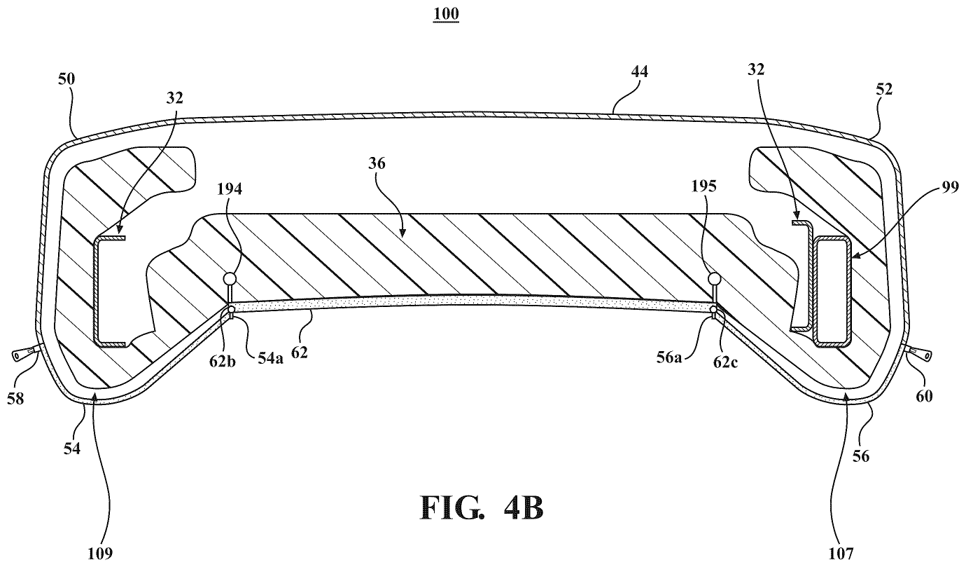

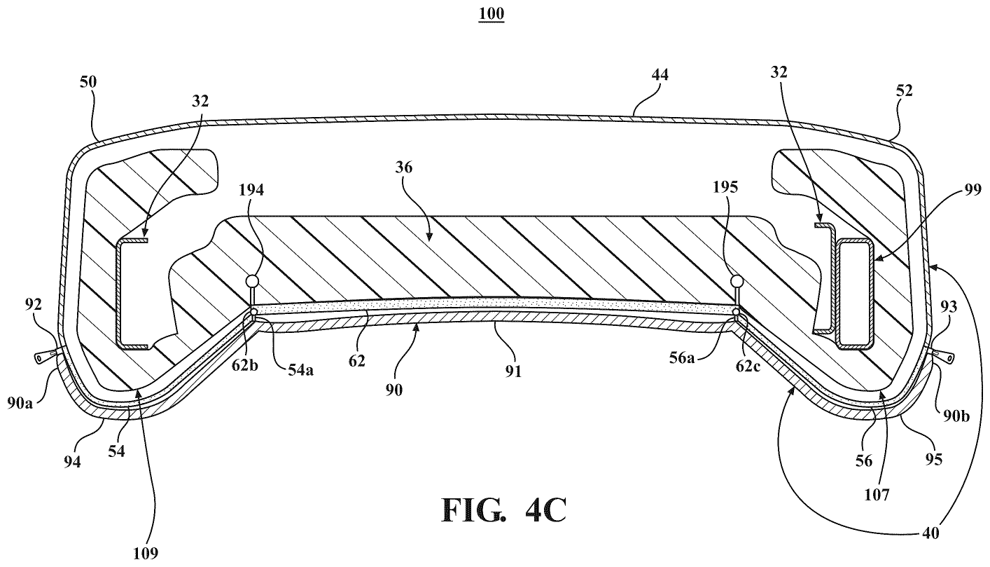

Referring to FIGS. 4A-4C, the backrest 100 may have a frame 32 structured to enable attachment of seat padding 36 and one or more seat covers thereto. The backrest frame 32 may define structure that (when suitably padded) support various portions of a seat occupant's upper body in a desired manner. for example, the backrest frame 32 may include supporting structure for seat bolsters which may operate to support an occupant along the sides of the seat 28, help keep a driver in control during an emergency, to help keep a driver's body in the proper posture, and to prevent the driver from sliding sideways during turns. The backrest frame 32 may be formed from a suitably rigid material such as metal or a polymer, for example. An airbag module 99 may be attached to the frame 32 prior to application of the trim cover assembly 40 to the seat frame as described herein.

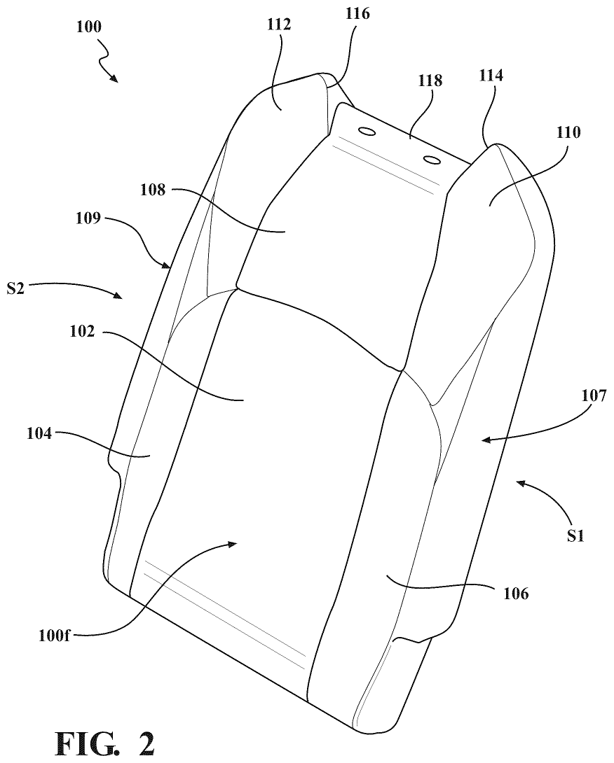

The backrest 100 may have padding (e.g., foam padding) wrapped over the backrest frame 32 so as to overlie portions of the frame 32 and cushion the seat occupant. FIG. 2 is a schematic frontal perspective view of the backrest 100 of the vehicle seat of FIG. 1, showing various portions of the backrest as covered by associated sections of padding applied over the frame 32, and prior to application of any trim covers to the backrest. Referring to FIG. 2, in one or more arrangements, the backrest 100 may have a lower portion 102, and an upper portion 108 positioned above the lower portion 102 of the backrest 100. The backrest 100 may include a left side bolster 107 having a lower portion 106 and an upper portion 110 extending from a left edge of the backrest 100. The backrest 100 may also include a right side bolster 109 having a lower portion 104 and an upper portion 112 extending from a right edge of the backrest 100. In addition, the left side bolster 107 may include a left upper bolster end portion 114 angling inwardly and downwardly toward a centrally-positioned headrest portion 118 of the backrest 100. Similarly, the right side bolster 109 may include a right upper bolster end portion 116 angling inwardly and downwardly toward the headrest portion 118. The backrest frame 32 may also have additional elements (e.g., seat heater mats) of the seat 28 attached thereto.

In its assembled form, the seat backrest 100 may include a backrest trim cover assembly (generally designated 40) applied to the padded backrest. As used herein, “applied” refers to attachment of an element of the backrest trim cover assembly to the backrest or to another element of the backrest trim cover assembly during the vehicle seat fabrication process.

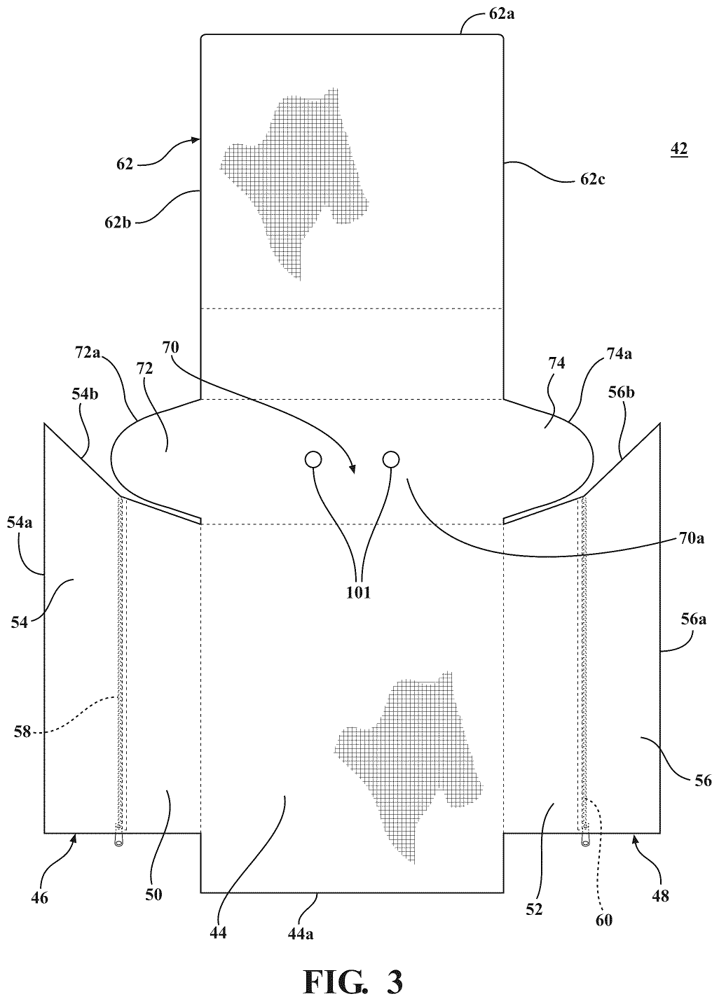

In one or more arrangements, backrest trim cover assembly 40 may include a base trim cover 42 structured to be applied over the backrest 100. FIG. 3 is a schematic plan view of a base trim cover 42 structured for covering the backrest of FIG. 2, shown laid out flat on a flat surface for purposes of illustration and description. In one or more arrangements, the base trim cover 42 may be formed from a mixture of different materials stitched or otherwise joined together. For example, second side bolster portion 54, first side bolster portion 56, and backrest center portion 62 may be formed from Duon® or a similar material. Other portions of the base trim cover 42 may be formed from materials such as fabric, polyurethane, PVC and/or leather.

In one or more arrangements, the base trim cover 42 may include a base trim cover rear portion 44 including a lower edge 44a. The base trim cover 42 may also have a first side portion 48 (in this case, a left side portion) extending from the base trim cover rear portion 44. The first side portion 48 may be structured to be wrappable along a respective first side S1 (FIG. 2) of the backrest 100. The first side portion 48 may have a first connecting portion 52 extending from the rear portion 44, and a first side bolster portion 56 extending from the first connecting portion 52. The first side bolster portion 56 may be structured to be wrappable over an associated first (or left) side bolster 107 of the backrest 100 to cover the first side bolster. The first side bolster portion 56 may also be structured to be securable to the backrest 100 along the backrest front face 100f.

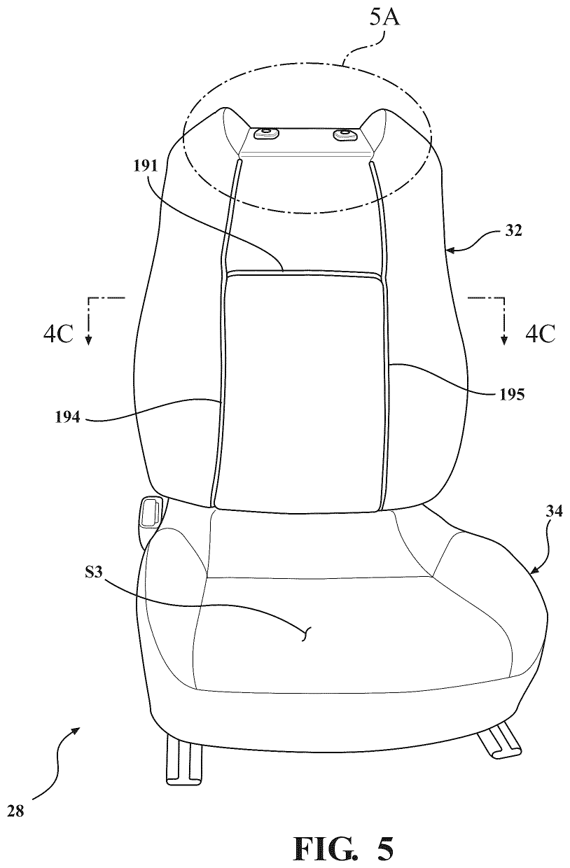

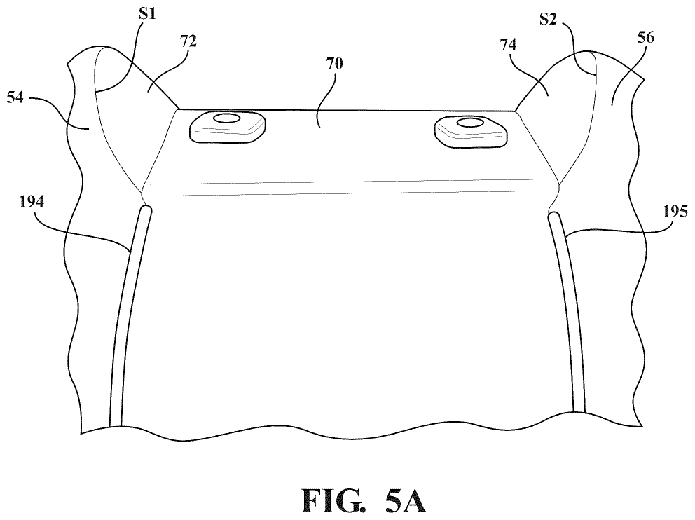

The first side portion 48 may have a side edge 56a structured to be securable to the backrest 100 along the backrest front face 100f. In one or more arrangements, the side edge 56a is located along the first side bolster portion 56. The first side portion side edge 56a may be structured to be securable to the padding along a trench or seam 195 (FIGS. 5, 5A) using suitable fasteners (e.g., hog-rings, EZ clips, hook and loop tape, arrow-hooks, stitching, etc.) and conventional upholstery securement methods. The first side portion 48 may have an upper edge 56b structured for attachment to an associated first side portion 74 of the headrest cover portion 70 (described in greater detail below).

In one or more arrangements, the first side portion 48 may include an outwardly-facing first zipper portion 60 attached to the first side portion 48 proximate a junction between first connecting portion 52 and the first side bolster portion 56. An “outwardly-facing zipper portion” may be a zipper portion attached so as to face away from the seat 28 when the base trim cover is applied to the backrest 100, so as to enable teeth of the zipper portion to be engaged with complementary teeth of a mating zipper portion by application of an associated slider and a pull tab, to bring together and mate the teeth of the zipper portions in a conventional manner. A “zipper portion” may be a portion of a zipper (e.g., a set of zipper teeth, a slider, etc.) operably connected to and/or structured to interact with another portion (i.e., a complementary, mating set of teeth) of the zipper.

The base trim cover 42 may also have a second side portion 46 (in this case, a right side portion) extending from the rear portion 44. The second side portion 46 may be structured to be wrappable along a respective second side S2 of the backrest. The second side portion 46 may have a second connecting portion 50 extending from the rear portion 44, and a second side bolster portion 54 extending from the second connecting portion 50. The second side bolster portion 54 may be structured to be wrappable over an associated second side bolster 109 of the backrest to cover the second side bolster. The second side bolster portion 54 may also be structured to be securable to the backrest 100 along the backrest front face 100f.

The second side portion 46 may also have a side edge 54a structured to be securable to the backrest 100 along the front face 100f of the backrest. In one or more arrangements, the side edge 54a is located along the second side bolster portion 54. The second side portion side edge 54a may be structured to be securable to the padding along a trench or seam 194 using suitable fasteners (e.g., hog-rings, EZ clips, hook and loop tape, arrow-hooks, stitching, etc.) and conventional upholstery securement methods. The second side portion 46 may have an upper edge 54b structured for attachment to an associated second side portion 72 of the headrest cover portion 70 (described in greater detail below).

In one or more arrangements, the second side portion 46 may include an outwardly-facing second zipper portion 58 attached to the second side portion proximate a junction between second connecting portion 50 and the second side bolster portion 54.

Referring to FIGS. 1 and 3, embodiments of the base trim cover 42 may have a headrest cover portion 70 extending from an upper edge of the base trim cover rear portion 44. The headrest cover portion 70 may be structured to be wrappable over the backrest headrest portion 118 from the rear face 100r of the backrest 100, and securable therealong to cover the headrest portion 118. The headrest cover portion 70 may have a headrest cover base portion 70a extending from the base trim cover rear portion 44. A headrest cover portion first side portion 74 may extend from the headrest cover base portion 70a, and a headrest cover portion second side portion 72 may extend from the headrest cover base portion 70a opposite the headrest cover first side portion 74. The headrest cover portion 70 may include holes 101 structured to accommodate supports for an associated headrest (not shown).

Referring to FIGS. 1 and 3, embodiments of the base trim cover 42 may have a backrest center portion 62 operably connected to the base trim cover rear portion 44. As used herein, “operably connected to” refers both to connections or attachments involving direct physical contact and also indirect physical contact. In one or more arrangements, the backrest center portion 62 may be attached to (and extend from) the headrest cover portion 70. The backrest center portion 62 may be structured to be wrappable over the backrest front face 100f and securable therealong to cover the backrest front face.

The backrest center portion 62 may include a bottom edge 62a structured to be securable to a bottom portion of the backrest 100 or to the backrest frame 32 below the level of an upper surface S3 (FIG. 1) of the seat bottom 34. The backrest center portion 62 may include a first side edge 62c and a second side edge 62b opposite the first side edge. the backrest center portion 62 may also be structured to be securable to the padding 36 along a trench 191 (FIG. 5) formed in the backrest 100, using suitable fasteners (e.g., hog-rings, EZ clips, hook and loop tape, arrow-hooks, stitching, etc.) and conventional upholstery securement methods. The trench 191 may separate the backrest front face 100f into the backrest upper portion 108 and the backrest lower portion 102.

Referring to FIGS. 1 and 3, embodiments of the trim cover assembly may include a removable trim cover 90 structured to be securable to the base trim cover 42 along the backrest 100 after the base trim cover has been attached to the backrest, to cover a portion of the base trim cover 42. In one or more arrangements, the removable trim cover 90 may include a center portion 91, a first bolster cover portion 95 extending from the removable trim cover center portion 91, and a second bolster cover portion 94 extending from the removable trim cover center portion 91 opposite first bolster cover portion 95.

The removable trim cover first bolster cover portion 95 may be structured to be wrappable over a portion of the base trim cover first side bolster portion 56. The removable trim cover first bolster cover portion 95 may have a first side edge 93 with a zipper portion 90b extending therealong to enable the removable trim cover first bolster cover portion 95 to be zipped to the base trim cover first side bolster portion 56. The removable trim cover first bolster cover portion 95 may be structured to be securable to the padding 36 along the trench 195 using suitable fasteners (e.g., hog-rings, EZ clips, hook and loop tape, arrow-hooks, stitching, etc.) and conventional upholstery securement methods.

The removable trim cover second bolster cover portion 94 may be structured to be wrappable over the base trim cover second side bolster portion 54. The removable trim cover second bolster cover portion 94 may have a second side edge 92 with a zipper 90a extending therealong to enable the removable trim cover second bolster cover portion 94 to be zipped to the base trim cover second side bolster portion 54. The removable trim cover second bolster cover portion 94 may be structured to be securable to the padding along the trench 194 using suitable fasteners (e.g., hog-rings, EZ clips, hook and loop tape, arrow-hooks, stitching, etc.) and conventional upholstery securement methods.

FIGS. 1 and 4A-4C illustrate a method of attaching the base trim cover 42 and the removable trim cover 90 to a backrest sub-assembly including the backrest frame 32 and desired padding 36 already applied to the backrest frame.

In a first step, the base trim cover rear portion 44 is applied to the rear face 100r of the backrest 100 in a position from which the base trim cover headrest cover portion 70 (FIG. 3) and base trim cover first and second side portions 48, 46 can be wrapped over respective side portions S1, S2 of the backrest into positions where they may be secured to the backrest.

Next, the base trim cover first and second side portions 48, 46 may be wrapped around respective sides S1, S2 of the backrest 100 and over the respective first and second side bolsters 107, 109 to the front face 100f of the backrest 100. The first side portion side edge 56a may then be secured to the padding 36 along trench 195 using suitable fasteners (e.g., hog-rings, EZ clips, hook and loop tape, arrow-hooks, stitching, etc.) and conventional upholstery securement methods. Also, the second side portion side edge 54a may be secured to the padding 36 along trench 195 using suitable fasteners (e.g., hog-rings, EZ clips, hook and loop tape, arrow-hooks, stitching, etc.) and conventional upholstery securement methods.

Next, headrest cover portion 70 may be wrapped over the top of the backrest 100 to cover the backrest headrest portion 118. Then the backrest center portion 62 may be wrapped over the backrest front face 100f to cover the front face.

Next, the upper bolster first end portion 114 may be covered by bringing together first side portion upper edge 56b with headrest cover portion first edge 74a and connecting these edges with stitching to form a seam. Also, the upper bolster second end portion 116 may be covered by bringing together second side portion upper edge 54b with headrest cover portion second edge 72a and connecting these edges with stitching to form a seam.

The backrest center portion 62 may then be attached to the padding 36 along trenches 195 and 194 using suitable fasteners (e.g., hog-rings, EZ clips, hook and loop tape, arrow-hooks, stitching, etc.) and conventional upholstery securement methods. The backrest center portion 62 may then be attached to the padding along trench 191 using suitable fasteners (e.g., hog-rings, EZ clips, hook and loop tape, arrow-hooks, stitching, etc.) and conventional upholstery securement methods. Bottom edge 62a of the backrest center portion 62 may then be attached to the backrest 100 or to the backrest frame 32 below the level of the upper surface S3 of the seat bottom 34, using a suitable attachment method. The base trim cover structures described herein allow attachment of the base trim cover to the backrest without use of zippers and listing wire.

Next, after application of the base trim cover 42 to the backrest 100, the removable trim cover 90 may be applied to the backrest 100 to cover portions of the base trim cover 42. To apply the removable trim cover 90, the removable trim cover center portion 91 may be positioned over a desired portion of the already-attached base trim cover rear portion 44. Then, the removable trim cover center portion 91 may be secured to the base trim cover 42 and backrest padding 36 along trenches 194 and 195 using suitable fasteners (e.g., hog-rings, EZ clips, hook and loop tape, arrow-hooks, stitching, etc.) and conventional upholstery securement methods.

Next, first side edge 93 of the removable trim cover 90 may be attached to the base trim cover 42 by zipping together zipper portions 90b and 60. Also, second side edge 92 of the removable trim cover 90 may be attached to the base trim cover 42 by zipping together zipper portions 90a and 58.

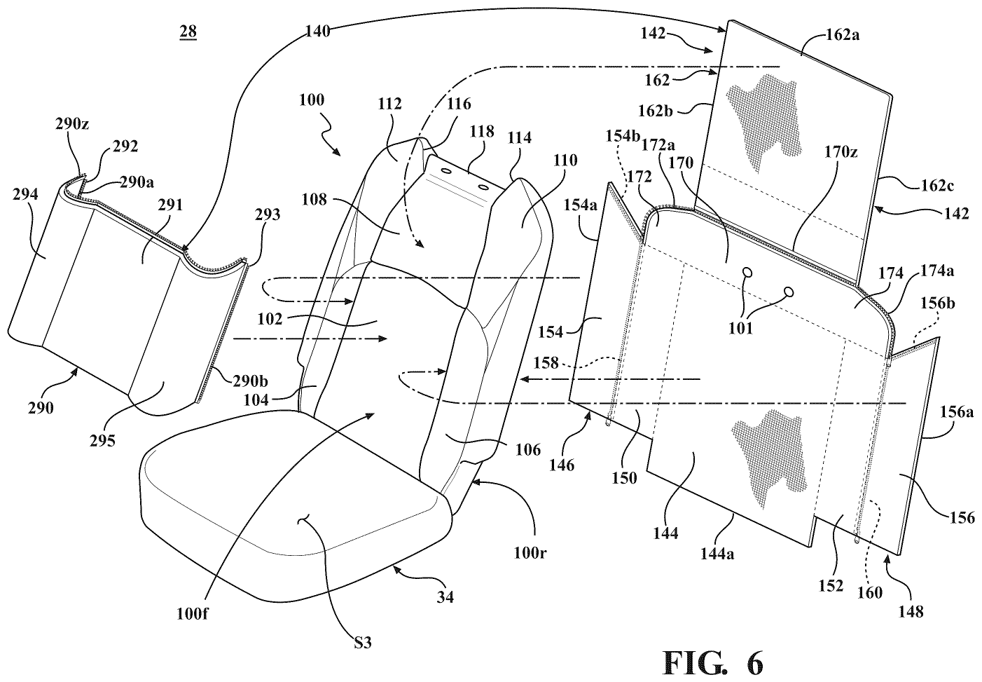

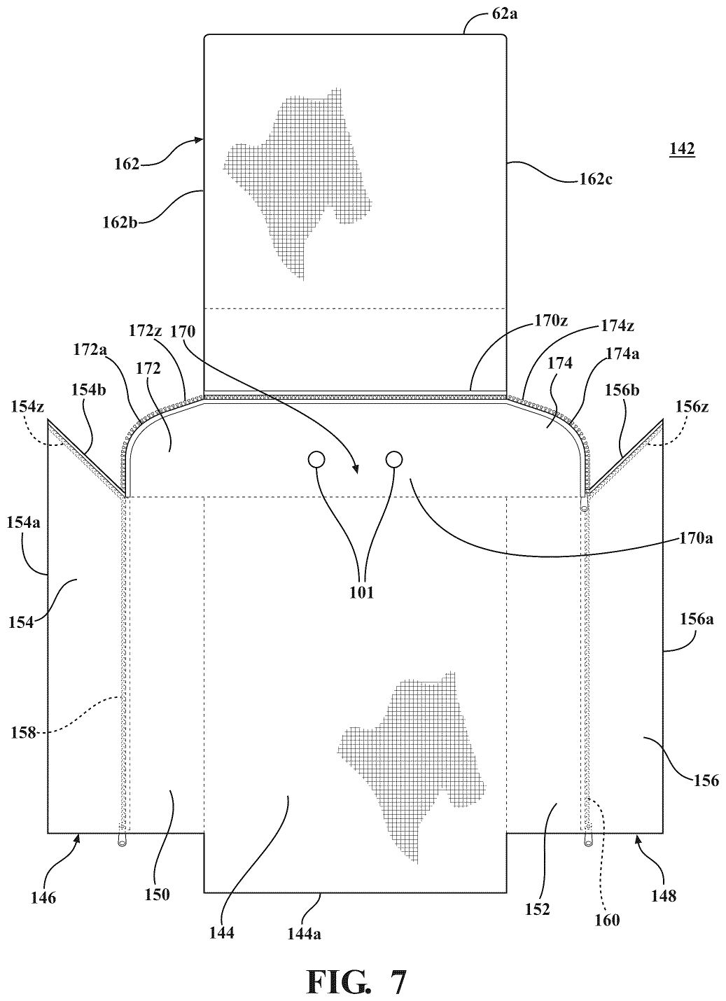

FIG. 6 is a schematic exploded perspective view of a vehicle seat incorporating a trim cover assembly in accordance with an alternative embodiment 140 described herein. FIG. 7 is a schematic plan view of a base trim cover 142 structured for covering the backrest of FIG. 2, in accordance with an alternative embodiment described herein. Referring to FIGS. 6 and 7, in alternative arrangements, the base trim cover 142 may include a base trim cover rear portion 144 including a lower edge 144a. The base trim cover 142 may also have a first side portion 148 (in this case, a left side portion) extending from the base trim cover rear portion 144. The first side portion 148 may be structured to be wrappable along a respective first side S1 (FIG. 2) of the backrest 100. The first side portion 148 may have a first connecting portion 152 extending from the rear portion 144, and a first side bolster portion 156 extending from the first connecting portion 152. The first side bolster portion 156 may be structured to be wrappable over an associated first (or left) side bolster 107 of the backrest 100 to cover the side bolster. The first side bolster portion 156 may also be structured to be securable to the backrest 100 along the backrest front face 100f.

The first side portion 148 may have a side edge 156a structured to be securable to the backrest 100 along the backrest front face 100f. In one or more arrangements, the side edge 156a is located along the first side bolster portion 156. The first side portion side edge 156a may be structured to be securable to the padding along trench 195 (FIGS. 5, 5A) using suitable fasteners (e.g., hog-rings, EZ clips, hook and loop tape, arrow-hooks, stitching, etc.) and conventional upholstery securement methods. The first side portion 148 may have an upper edge 156b structured for attachment to an associated first side portion 174 of the headrest cover portion 170. In certain arrangements, the upper edge 156b may have an outwardly-facing zipper portion 156z extending therealong to enable zipped attachment to a complementary outwardly-facing zipper portion 174z extending along edge 174a. In one or more arrangements, the first side portion 148 may also include an outwardly-facing first zipper portion 160 attached to the first side portion 148 proximate a junction between first connecting portion 152 and the first side bolster portion 156.

The base trim cover 142 may also have a second side portion 146 (in this case, a right side portion) extending from the rear portion 144. The second side portion 146 may be structured to be wrappable along a respective second side S2 of the backrest. The second side portion 146 may have a second connecting portion 150 extending from the rear portion 144, and a second side bolster portion 154 extending from the second connecting portion 150. The second side bolster portion 154 may be structured to be wrappable over an associated second side bolster 109 (FIG. 2) of the backrest 100 to cover the second side bolster. The second side bolster portion 154 may also be structured to be securable to the backrest 100 along the backrest front face 100f.

The second side portion 146 may also have a side edge 154a structured to be securable to the backrest 100 along the front face 100f of the backrest. In one or more arrangements, the side edge 154a is located along the second side bolster portion 154. The second side portion side edge 154a may be structured to be securable to the padding along a trench or seam 194 using suitable fasteners (e.g., hog-rings, EZ clips, hook and loop tape, arrow-hooks, stitching, etc.) and conventional upholstery securement methods. The second side portion 146 may have an upper edge 154b structured for attachment to an associated second side portion 172 of the headrest cover portion 170 (described in greater detail below). In certain arrangements, the upper edge 154b may have an outwardly-facing zipper portion 154z extending therealong to enable zipped attachment to a complementary outwardly-facing zipper portion 172z extending along edge 172a. In one or more arrangements, the second side portion 146 may also include an outwardly-facing second zipper portion 158 attached to the second side portion proximate a junction between second connecting portion 150 and the second side bolster portion 154.

Referring to FIGS. 6 and 7, embodiments of the base trim cover 142 may also have a headrest cover portion 170 extending from an upper edge of the base trim cover rear portion 144. The headrest cover portion 170 may be structured to be wrappable over the backrest headrest portion 118 from the rear face 100r of the backrest 100, and securable therealong to cover the headrest portion 118. The headrest cover portion 170 may have a headrest cover base portion 170a extending from the base trim cover rear portion 144. A headrest cover portion first side portion 174 may extend from the headrest cover base portion 170a, and a headrest cover portion second side portion 172 may extend from the headrest cover base portion 170a opposite the headrest cover first side portion 174. The headrest cover portion 170 may include holes 201 structured to accommodate supports for an associated headrest (not shown).

The base trim cover 142 may also include an outwardly-facing zipper portion 170z extending along an edge of the headrest cover portion 170, between zipper portions 174z and 172z and between headrest cover first side portion 174 and headrest cover second side portion 172. In particular arrangements, the zipper portions 158, 172z, 170z, 174z, and 160 are formed integrally or connected as a single, continuous zipper portion, and may have multiple sliders (not shown) slidingly attached thereto, each slider being configured for enabling zipping engagement between an associated one of the zipper portions 158, 172z, 170z, 174z, and 160 and a complementary zipper portion.

Referring to FIGS. 6 and 7, embodiments of the base trim cover 142 may have a backrest center portion 162 operably connected to the base trim cover rear portion 144. In one or more arrangements, the backrest center portion 162 may be attached to (and extend from) the headrest cover portion 170. The backrest center portion 162 may be structured to be wrappable over the backrest front face 100f and securable therealong to cover the backrest front face. The backrest center portion 162 may include a bottom edge 162a structured to be securable to a bottom portion of the backrest 100 or to the backrest frame 32 below the level of an upper surface S3 (FIG. 1) of the seat bottom 34. The backrest center portion 162 may include a first side edge 162c and a second side edge 162b opposite the first side edge. the backrest center portion 162 may also be structured to be securable to the padding 36 along trench 191 (FIG. 5) formed in the backrest 100, using suitable fasteners (e.g., hog-rings, EZ clips, hook and loop tape, arrow-hooks, stitching, etc.) and conventional upholstery securement methods.

In one or more arrangements, during application of the trim cover assembly 140, the previously-described removable trim cover 90 may be zipped to zipper portions 158 and 160 in the manner previously described with respect to zipper portions 58 and 60. Referring to FIGS. 6 and 7, in an alternative arrangement 290 of the removable trim cover, an additional zipper portion 290z may extend along an upper edge of the removable trim cover. The zipper portion 290z may be structured to be zippable to zipper portion 170z on base trim cover 142 to aid in attaching removable trim cover 290 to base trim cover 142. The removable trim cover 290 may otherwise be structured the same as removable trim cover 90, with a center portion 291, a first bolster cover portion 295 extending from the removable trim cover center portion 291, and a second bolster cover portion 294 extending from the removable trim cover center portion 291 opposite first bolster cover portion 295.

The removable trim cover first bolster cover portion 295 may be structured to be wrappable over a portion of the base trim cover first side bolster portion 156. The removable trim cover first bolster cover portion 295 may have a first side edge 293 with a zipper portion 290b extending therealong to enable the removable trim cover first bolster cover portion 295 to be zipped to the base trim cover first side bolster portion 156. The removable trim cover first bolster cover portion 295 may be structured to be securable to the padding 36 along the trench 195 using suitable fasteners (e.g., hog-rings, EZ clips, hook and loop tape, arrow-hooks, stitching, etc.) and conventional upholstery securement methods.

The removable trim cover second bolster cover portion 294 may be structured to be wrappable over the base trim cover second side bolster portion 154. The removable trim cover second bolster cover portion 294 may have a second side edge 292 with a zipper portion 290a extending therealong to enable the removable trim cover second bolster cover portion 294 to be zipped to the base trim cover second side bolster portion 154. The removable trim cover second bolster cover portion 294 may be structured to be securable to the padding along the trench 194 using suitable fasteners (e.g., hog-rings, EZ clips, hook and loop tape, arrow-hooks, stitching, etc.) and conventional upholstery securement methods.

The method of attaching the base trim cover 142 and the removable trim cover 290 to the backrest sub-assembly may be similar to the method of attaching the previously-described method of attaching the base trim cover 42 and the removable trim cover 90 to the backrest sub-assembly. In a first step, the base trim cover rear portion 144 is applied to the rear face 100r of the backrest 100 in a position from which the base trim cover headrest cover portion 170 (FIG. 7) and base trim cover first and second side portions 148, 146 can be wrapped over respective side portions S1, S2 of the backrest into positions where they may be secured to the backrest.

Next, the base trim cover first and second side portions 148, 146 may be wrapped around respective sides S1, S2 of the backrest 100 and over the respective first and second side bolsters 107, 109 to the front face 100f of the backrest 100. The first side portion side edge 156a may then be secured to the padding 36 along trench 195 using suitable fasteners (e.g., hog-rings, EZ clips, hook and loop tape, arrow-hooks, stitching, etc.) and conventional upholstery securement methods. Also, the second side portion side edge 154a may be secured to the padding 36 along trench 195 using suitable fasteners (e.g., hog-rings, EZ clips, hook and loop tape, arrow-hooks, stitching, etc.) and conventional upholstery securement methods.

Next, headrest cover portion 170 may be wrapped over the top of the backrest 100 to cover the backrest headrest portion 118. Then the backrest center portion 162 may be wrapped over the backrest front face 100f to cover the front face.

Next, the upper bolster first end portion 114 may be covered by bringing together first side portion upper edge 156b with headrest cover portion first edge 174a and connecting these edges by zipping together zipper portions 156z and 174z. Also, the upper bolster second end portion 116 may be covered by bringing together second side portion upper edge 154b with headrest cover portion second edge 172a and connecting these edges by zipping together zipper portions 154z and 172z.

The backrest center portion 162 may then be attached to the padding 36 along trenches 195 and 1944 using suitable fasteners (e.g., hog-rings, EZ clips, hook and loop tape, arrow-hooks, stitching, etc.) and conventional upholstery securement methods. The backrest center portion 162 may then be attached to the padding along trench 191 using suitable fasteners (e.g., hog-rings, EZ clips, hook and loop tape, arrow-hooks, stitching, etc.) and conventional upholstery securement methods. Bottom edge 162a of the backrest center portion 162 may then be attached to the backrest 100 or to the backrest frame 132 below the level of the upper surface S3 of the seat bottom 34, using a suitable attachment method. The base trim cover structures described herein allow attachment of the base trim cover to the backrest without use of zippers and listing wire.

Next, after application of the base trim cover 142 to the backrest 100, the removable trim cover 290 may be applied to the backrest 100 to cover portions of the base trim cover 142. To apply the removable trim cover 290, the removable trim cover center portion 296 may be positioned over a desired portion of the already-attached base trim cover rear portion 144. Then, the removable trim cover center portion 296 may be secured to the base trim cover 142 and backrest padding 36 along trenches 194 and 195 using suitable fasteners (e.g., hog-rings, EZ clips, hook and loop tape, arrow-hooks, stitching, etc.) and conventional upholstery securement methods.

Next, first side edge 293 of the removable trim cover 290 may be attached to the base trim cover 142 by zipping together zipper portions 290b and 160. Also, second side edge 292 of the removable trim cover 290 may be attached to the base trim cover 142 by zipping together zipper portions 290a and 158. In arrangements of the including zipper portion 290z, this zipper portion may be zipped to base trim cover zipper portion 170z.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A trim cover assembly structured to be applied to a backrest of a vehicle seat, the trim cover assembly comprising a base trim cover including:
a rear portion;
first side portion extending from a first side of the rear portion; and
a second side portion extending from a second side of the rear portion opposite the first side portion,
each side portion being structured to be wrappable along a respective side of the backrest, each side portion having a side edge structured to be securable to the backrest along a front face of the backrest.

2. The trim cover assembly of claim 1, wherein each base trim cover side portion comprises;
a connecting portion extending from the rear portion; and
a side bolster portion extending from the connecting portion, structured to be wrappable over an associated side bolster of the backrest to cover the side bolster, and structured to be securable to the backrest along the backrest front face.

3. The trim cover assembly of claim 1, wherein each side portion has an outwardly-facing zipper portion extending therealong.

4. The trim cover assembly of claim 1, further comprising a headrest cover portion extending from the base trim cover rear portion and structured to be wrappable over a headrest portion of the backrest, the headrest cover portion including:
a headrest cover base portion extending from the base trim cover rear portion;
a headrest cover first side portion extending from a first side of the headrest cover base portion; and
a headrest cover second side portion extending from a second side of the headrest cover base portion opposite the headrest cover first side portion.

5. The trim cover assembly of claim 4, further comprising a backrest center portion operably connected to the base trim cover rear portion and including a bottom edge securable to the backrest to cover a front face of the backrest.

6. The trim cover assembly of claim 1, further comprising a removable trim cover structured to be securable to the base trim cover along the backrest, the removable trim cover including;
a center portion;
a first bolster cover portion extending from the removable trim cover center portion and having a first side edge with a zipper portion extending therealong; and
a second bolster cover portion extending from the removable trim cover center portion opposite first bolster cover portion and having a second side edge with a zipper portion extending therealong.

7. A method for attaching a trim cover assembly to a vehicle backrest, comprising steps of:
applying a portion of a base trim cover to the backrest, including wrapping first and second side portions of the base trim cover along respective sides of the backrest from a rear face of the backrest toward a front face of the backrest; and
securing the first and second side portions of the base trim cover to the backrest along the front face of the backrest.

8. The method of claim 7, wherein the base trim cover includes a headrest cover portion, and further comprising steps of:
wrapping the headrest cover portion over the headrest portion toward the front face of the backrest so as to cover the backrest headrest portion; and
securing the headrest cover portion to the backrest.

9. The method of claim 7, wherein the base trim cover includes a backrest cover portion, and further comprising steps of:
wrapping the backrest cover portion around a headrest portion of the backrest toward the front face of the backrest so as to cover a portion of the backrest front face; and
securing the backrest cover portion to the backrest along the backrest front face.

10. The method of claim 7, further comprising a step of securing a removable trim cover to the base trim cover along opposite sides of the backrest, so as to cover a portion of the base trim cover along the front face of the backrest.
